(19) United States
(12) Patent Application Publication
(10) Pub. No.: US 2008/0049170 A1
(43) Pub. Date: Feb. 28, 2008

(54) LIQUID CRYSTAL DISPLAY

(75) Inventors: Kyung-Ho HWANG, Yongin-si (KR); Kil-Soo CHOI, Suwon-si (KR); Kon-Ho LEE, Seoul (KR); Sun-Hyung CHOI, Hwaseong-si (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si (KR)

(21) Appl. No.: 11/845,334

(22) Filed: Aug. 27, 2007

(30) Foreign Application Priority Data
Aug. 28, 2006 (KR) 10-2006-0081682

(51) Int. Cl. G02F 1/1335

(52) U.S. Cl. 349/69

(57) ABSTRACT

A liquid crystal display (“LCD) includes: a first display panel; a second display panel; a light source unit for providing light to the first and second display panels and including a plurality of lamps; and a driving circuit chip for driving both the first and second display panels, wherein the driving circuit chip includes a lamp driver for providing a plurality of voltages and a uniform current to the light source unit.

This application claims priority to Korean Patent Application No. 10-2006-0081682, filed on Aug. 28, 2006, and all the benefits accruing therefrom under 35 U.S.C. §119, the contents of which it its entirety are herein incorporated by reference.

### BACKGROUND OF THE INVENTION

(a) Field of the Invention

The present invention relates to a liquid crystal display (“LCD”).

(b) Description of the Related Art

In general, an LCD includes two display panels, one with pixel electrodes and the other with a common electrode formed thereon and a liquid crystal layer having dielectric anisotropy interposed between. The pixel electrodes are arranged in matrix form and connected with switching elements such as thin film transistors (“TFTs”) so as to sequentially receive data voltages one row by one row. The common electrode is formed on the entire surface of the respective display panel and receives a common voltage. The pixel electrodes, the common electrode and the liquid crystal layer interposed therebetween form liquid crystal capacitors in terms of circuitry, and the liquid crystal capacitors are basic units for forming pixels together with switching elements connected thereto.

In an LCD, voltages are applied to the two electrodes to generate an electric field at the liquid crystal layer, and the strength of the electric field is controlled to control transmittance of light which passes through the liquid crystal layer, thus obtaining desired images. In this case, in order to prevent degradation generated as the electric field is applied for a long time in one direction to the liquid crystal layer, polarity of data voltages applied to the pixel electrodes with respect to the common voltage is inverted either by frames, rows or pixels.

Among the various types of LCDs, and as a small sized display device used for mobile phones, etc., a dual display device having outer and inner display panel parts is currently being developed.

The dual display device includes a main display panel mounted at an inner side, a sub-display panel mounted at an outer side, a driving flexible printed circuit film (“FPC”) having wiring for transferring an input signal, a main FPC positioned between the driving FPC and the main display panel, an auxiliary FPC positioned between the main display panel and the sub-display panel, and an integration chip for controlling them.

The integration chip generates signals for controlling the main display panel and the sub-display panel, and for driving signals. The integration chip is mainly mounted in the form of a chip on glass (“COG”) at the main display panel, and the driving FPC is also called an interface FPC in a sense that it connects an external device and the LCD.

The LCD includes a lamp for providing light to a liquid crystal panel assembly, the main display panel and the sub-display panel. An LED is commonly used as the lamp for providing light.

A lamp driver for driving the lamp is generally mounted at the main FPC or the driving FPC. However, the lamp driver causes an increase in fabrication cost and increases the required space for mounting the lamp driver.

### BRIEF SUMMARY OF THE INVENTION

The present invention has been made in an effort to provide a liquid crystal display (“LCD”) having an advantage of integrating a lamp driver in an integration chip.

An exemplary embodiment of the present invention provides an LCD including: a first display panel; a second display panel; a light source unit for providing light to the first and second display panels and including a plurality of lamps; and a driving circuit chip for driving the first and second display panels, wherein the driving circuit chip includes a lamp driver for providing a plurality of voltages and a uniform current to the light source unit.

The driving circuit chip may include a voltage generator for generating a plurality of driving voltages and the lamp driver may apply at least two of the plurality of driving voltages to the light source unit.

The lamp driver may include a constant current source for providing a uniform current.

The LCD may further include a first flexible printed circuit (FPC) film attached on the first display panel and a connection part connected between the first FPC and the light source unit. Herein, the lamp can be a light emitting diode (LED).

Differently, the LCD may further include a first FPC attached on the first display panel and a second FPC having a cutout portion exposing the second display panel, and the lamp may be mounted on the first FPC or the second FPC.

The driving circuit chip may include a DC/DC converter for generating the plurality of driving voltages based on an input voltage, and the voltage generator can be the DC/DC converter.

The driving circuit chip may include a gray voltage generator for generating a plurality of gray voltages, and the voltage generator can be the gray voltage generator.

The first and second display panels may include a plurality of pixels each including a switching element, and first and second signal lines connected with the switching elements, respectively.

The LCD may further include a gate driver for generating a gate signal and applying it to the first signal lines, a data driver for generating a data voltage and applying it to the second signal lines, and the driving circuit chip may further include the gate driver and the data driver.

The driving circuit chip may be mounted on the first display panel.

### BRIEF DESCRIPTION OF THE DRAWINGS

The accompanying drawings briefly described below illustrate exemplary embodiments of the present invention and, together with the description, serve to explain the principles of the present invention, in which:

FIG. 1 is a schematic block diagram of an exemplary embodiment of a liquid crystal display (“LCD”) according to the present invention;

FIG. 2 is an equivalent circuit diagram showing an exemplary embodiment of a single pixel of the LCD of FIG. 1 according to the present invention;

FIGS. 3A and 3B are schematic diagrams showing the exemplary embodiment of the LCD of FIG. 1 according to the present invention;

FIG. 4A is a view showing voltages generated from a lamp driver;

FIGS. 4B and 4C show forms of application of the voltages generated from the lamp driver when light emitting diodes (“LEDs”) are connected in parallel and in series, respectively;

FIG. 5A is a register generally included in an integrated circuit (IC);

FIG. 5B is a table showing an example of setting voltages using the register of FIG. 5A;

FIGS. 6A and 6B show examples of a constant current source and

FIG. 7 is a schematic diagram of an exemplary embodiment of the LCD of FIG. 3 in which lamps are mounted on a main FPC.

### DETAILED DESCRIPTION OF THE EMBODIMENTS

The invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

Hereinafter, the present invention will be described in detail with reference to the accompanying drawings.

An exemplary embodiment of a liquid crystal display (“LCD”) according to the present invention will now be described in further detail with reference to the accompanying drawings.

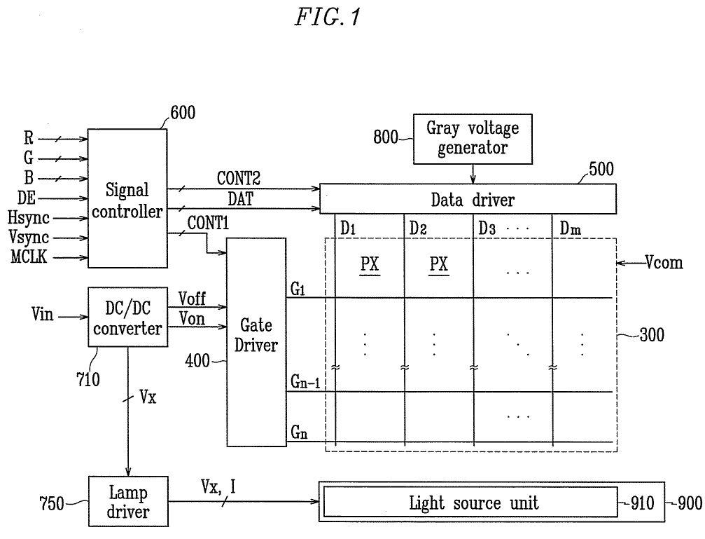

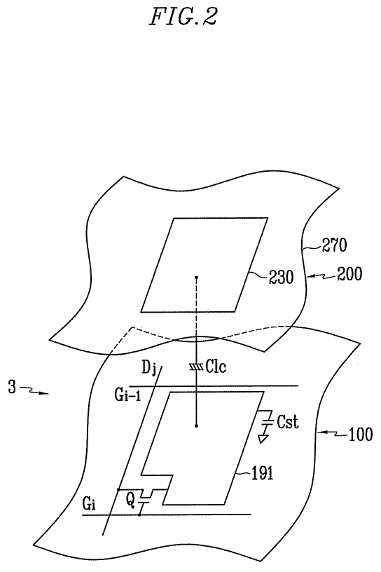

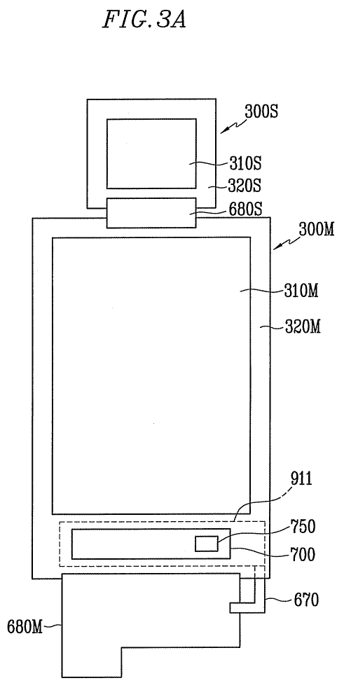

FIG. 1 is a schematic block diagram of a liquid crystal display (“LCD”) according to one exemplary embodiment of the present invention, FIG. 2 is an equivalent circuit diagram showing a single pixel of the LCD according to the one exemplary embodiment of the present invention, and FIGS. 3A and 3B are schematic diagrams showing the LCD according to the one exemplary embodiment of the present invention.

As shown in FIG. 1, the LCD according to the one exemplary embodiment of the present invention includes a liquid crystal panel assembly 300, a gate driver 400, a data driver 500, a gray voltage generator 800 connected with the data driver 500, a signal controller 600 for controlling them, and a backlight unit 900 for providing light to the liquid crystal panel assembly 300. The LCD according to the one exemplary embodiment of the present invention further includes a DC/DC converter 710 for generating driving voltages Von and Voff and a lamp driver 750 connected with the DC/DC converter 710.

Signal lines G1-Gn and D1-Dm include a plurality of gate lines G1-Gn for transferring gate signals (also called ‘scan signals’) and a plurality of data lines D1-Dm for transferring data voltages. The gate lines G1-Gn extend substantially in a row direction and are substantially parallel to each other, and the data lines D1-Dm extend substantially in a column direction and are substantially parallel to each other, as illustrated in FIG. 1.

Each pixel PX, i.e., a pixel PX connected with the ith gate line Gi (where i=1, 2, . . . n) and the jth data line Dj (where j=1, 2, . . . m), includes a switching element Q connected with the signal lines Gi and Dj, and a liquid crystal capacitor Clc and a storage capacitor Cst connected thereto, as illustrated with reference to both FIGS. 1 and 2. The storage capacitor Cst can be omitted if necessary.

The switching element Q is a three-terminal element, such as a thin film transistor (“TFT”), provided on the lower panel 100, which includes a control terminal connected with the gate line Gi, an input terminal connected with the data line Dj, and an output terminal connected with the liquid crystal capacitor Clc and the storage capacitor Cst.

The liquid crystal capacitor Clc has a pixel electrode 191 of the lower panel 100 and the common electrode 270 of the upper panel 200 as two terminals, respectively, and the liquid crystal layer 3 between the two electrodes 191 and 270 serves as a dielectric material. The pixel electrode 191 is connected with the switching element Q and the common electrode 270 is formed on the entire surface of the upper panel 200 and receives a common voltage (Vcom). Different from the case as shown in FIG. 2, the common electrode 270 can be provided on the lower panel 100, in which case, at least one of the two electrodes 191 and 270 can be formed in a linear or bar shape.

The storage capacitor Cst, which serves as an auxiliary to the liquid crystal capacitor Clc, is formed as a separate signal line (not shown) provided on the lower panel 100 and overlaps the pixel electrode 191 with an insulator interposed therebetween, and a predetermined voltage such as the common voltage Vcom or the like is applied to the separate signal line. Also, the storage capacitor Cst can be formed as the pixel electrode 191 overlaps the immediately previous gate line Gi−1 with the insulator therebetween as the dielectric material.

In order to implement color display, each pixel PX specifically displays one of the primary colors (e.g., spatial division) or the pixels PX alternately display the primary colors over time (e.g., temporal division), so that a desired color can be recognized by the spatial or temporal sum of the primary colors. The primary colors can be, for example, the three primary colors of red, green and blue, but is not limited thereto. FIG. 2 shows one example of spatial division in which each pixel PX includes a color filter 230 which displays one of the primary colors at a region of the upper panel 200 corresponding to the pixel electrode 191. Different from the color filter 230 as shown in FIG. 2, the color filter 230 can be formed above or below the pixel electrode 191 of the lower panel 100.

The backlight unit 900 includes a light source unit 910 including a plurality of lamps (not shown) mounted at a lower portion of the liquid crystal panel assembly 300. In the case of a medium or small-sized LCD, a light emitting diode (“LED”) is used as a lamp, and the backlight unit can be formed in an edge type in which lamps are disposed at a lower edge of the liquid crystal panel assembly 300 and a light guide is disposed to distribute the light from the edge mounted lamps.

A polarizer (not shown) for polarizing light emanated from the light source unit 910 is attached on an outer surface of each of the two display panels 100 and 200 of the liquid crystal panel assembly 300.

With reference to FIGS. 3A and 3B, the LCD according to the one exemplary embodiment of the present invention includes two display panels which include a main display panel 300M and a sub-display panel 300S. The display panels 300M and 300S include black matrixes 320M and 320S defining display regions 310M and 310S, respectively, and the pixels PX and the signal lines G1-Gn, D1-Dm are substantially positioned within the display regions 310M and 310S.

The main display panel 300M and the sub-display panel 300S are connected via an auxiliary FPC 680S. A main FPC 680M is attached at a lower side of the main display panel 300M, as illustrated in FIG. 3A. When the driving FPC 650 as shown in FIG. 3B is rotated 180°, the main FPC 680M (FIG. 3A) is attached at a lower side of the rotated part.

The driving FPC 650 is called an interface FPC and includes wiring (not shown) for transferring a signal and a pad (not shown) formed at an end portion thereof. The main FPC 680M and the auxiliary or sub-FPC 680S which contact with the pad of the driving FPC 650 and the respective display panels 300M and 300S also have pads, and a cutout portion 690 is formed where the sub-display panel 300S is positioned when the auxiliary FPC 680S is folded back, if combined.

The pad of the driving FPC 650, the pads of the main and sub-FPCs 680M and 680S, and the pads of the display panels 300M and 300S can be electrically connected by soldering or by using an anisotropic conductive film (“AFC”).

The light source unit 910 includes a PCB 911, indicated by a dotted line, having a lamp (not shown) mounted thereon, is provided at a rear side of the main display panel 300M, and receives a current control signal or the like from the lamp driver 750 through the main FPC 680M and the connection part 670. Alternatively, the lamp can be directly mounted on the main FPC 680M or the driving FPC 650.

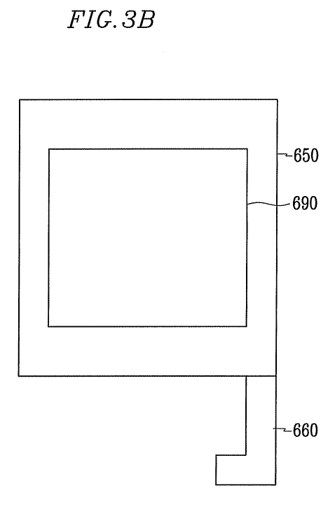

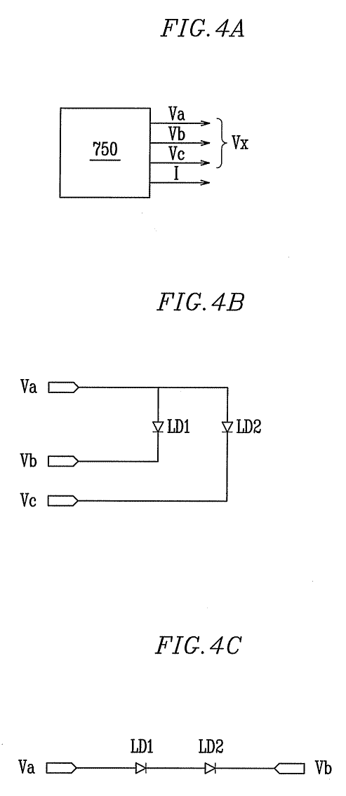

The integration chip 700 provides a signal which is processed upon receiving the signal through the input section 660 to the main display panel 300M and the sub-display panel 300S through the wiring provided at the main display panel 300M and the sub-display panel 300S. The integration chip 700 includes the lamp driver 750 for controlling a voltage Vx and a current I applied to the light source unit 910 of the backlight unit 900, as illustrated in FIGS. 1 and 4A.

With reference to FIG. 1, the DC/DC converter 710 amplifies an input voltage Vin from an external device and provides a plurality of voltages required for the drivers 400, 500, 600, 800, and 750.

The gray voltage generator 800 generates entire gray voltages related to a transmittance of the pixels PX or a limited number of gray voltages (referred to hereinafter as ‘reference gray voltage’). The (reference) gray voltages may include a positive value or a negative value with respect to the common voltage (Vcom).

The gate driver 400 is connected with the gate lines G1-Gn of the liquid crystal panel assembly 300 and applies a gate signal formed as a combination of a gate-on voltage Von and a gate-off voltage Voff from the DC/DC converter 710 to the gate lines G1-Gn.

The data driver 500 is connected with the data lines D1-Dm of the liquid crystal panel assembly 300, selects a gray voltage from the gray voltage generator 800, and applies the gray voltage as a data voltage to the data lines D1-Dm. In this respect, if the gray voltage generator 800 does not provide all of the reference gray voltages, but provides only a limited number of the reference gray voltages, the data driver 500 divides the reference gray voltages to generate a desired data voltage.

The signal controller 600 controls the gate driver 400 and the data driver 500.

As shown in FIG. 3A, the signal controller 600, the gate driver 400, the data driver 500, the gray voltage generator 800, the lamp driver 750, and the DC/DC converter 710 of FIG. 1 are implemented as the single integration chip 700 and mounted on the main display panel 300M in a form of chip on glass (“COG”).

The operation of the LCD will be described in further detail as follows.

The signal controller 600 receives input image signals R, G and B and input control signals for controlling display of the input image signals from an external graphics controller (not shown). The input image signals R, G and B include luminance information of each pixel PX, and the luminance information includes a determined number of gray levels, e.g., 1024 (=2¹⁰), 256 (=2⁸), or 64 (=2⁶) gray levels. The input control signals include, for example, a vertical synchronization signal Vsync, a horizontal synchronization signal Hsync, a main clock signal MCLK and a data enable signal DE.

The signal controller 600 properly processes the input image signals R, G and B according to operating conditions of the liquid crystal panel assembly 300 based on the input image signals R, G and B and the input control signal, generates a gate control signal CONT1 and a data control signal CONT2, etc., and transmits the gate control signal CONT1 to the gate driver 400 and transmits the data control signal CONT2 and the processed image signal DAT to the data driver 500.

The gate control signal CONT1 includes a scanning start signal STV for instructing starting of scanning and at least one clock signal for controlling an output of the gate-on voltage Von. The gate control signal CONT1 may additionally include an output enable signal OE for limiting duration of the gate-on voltage Von.

The data control signal CONT2 includes a horizontal synchronization start signal STH for informing of starting of transmission of the digital image data DAT to one row of pixels PX, a load signal LOAD for indicating application of an analog data voltage to the data lines D1-Dm, and a data clock signal HCLK. The data control signal CONT2 may additionally include an inversion signal RVS for inverting polarity of a data voltage with respect to the common voltage Vcom (which is hereinafter referred to as ‘polarity of data voltage’).

The data driver 500 receives the digital image signal DAT with respect to one row of pixels PX according to the data control signal CONT2 received from the signal controller 600, selects a gray voltage corresponding to each digital image signal DAT, converts the digital image signal DAT into an analog data voltage, and applies the analog data voltage to the corresponding data lines D1-Dm.

The gate driver 400 applies the gate-on voltage to the gate lines G1-Gn according to the gate control signal CONT1 from the signal controller 600 to turn on the switching elements Q (FIG. 2) connected with the gate lines G1-Gn. Then, the data voltage, which has been applied to the data lines D1-Dm, is applied to the corresponding pixels PX through the turned-on switching elements Q.

A difference between the data voltage applied to the pixels PX and the common voltage Vcom appears as a charge voltage, namely, a pixel voltage, of the liquid crystal capacitor Clc. Arrangement of liquid crystal molecules is changed according to the magnitude of the pixel voltage, and polarization of light, which transmits through the liquid crystal layer 3, is changed accordingly. The change in the polarization appears as a change in transmittance of light by a polarizer, whereby pixels PX display luminance represented by gray levels of the image signal DAT.

This process is repeatedly performed by unit of one horizontal period (namely, ‘1H’ which is equivalent to one period of the horizontal synchronization signal Hsync and the data enable signal DE), whereby the gate-on voltage Von is sequentially applied to all of the gate lines G1-Gn and the data voltage is applied to all of the pixels PX to thus display an image of one frame.

When one frame is finished, the next frame is started and a state of the inversion signal RVS applied to the data driver 500 is controlled (‘frame inversion’) so that a polarity of the data voltage applied to each pixel PX can be opposite to the polarity of the previous frame. In this case, even in one frame, the polarity of a data voltage flowing through one data line can be changed periodically according to characteristics of the inversion signal RVS (e.g., row inversion, dot inversion), or the polarity of a data voltage applied to one pixel row can be different (e.g., column inversion, dot inversion).

The LCD according to the one exemplary embodiment of the present invention will now be described in further detail with reference to FIG. 1 and FIGS. 4 to 7.

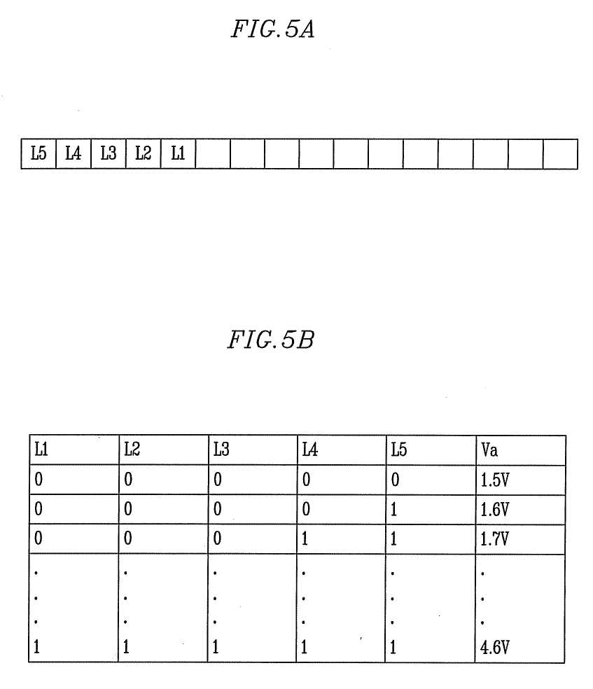

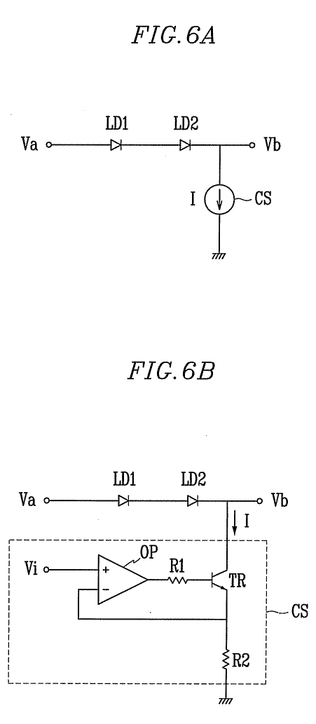

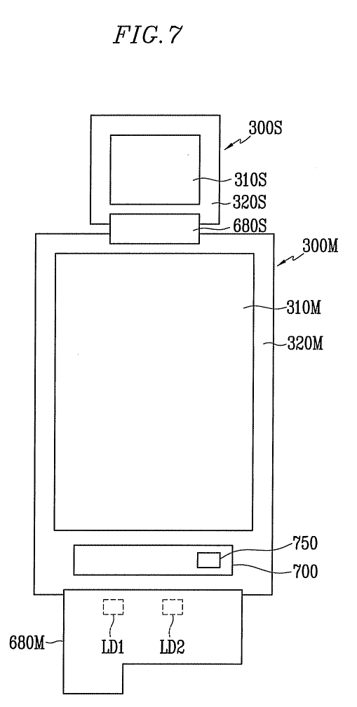

FIG. 4A is a view showing voltages generated from the lamp driver 750, and FIGS. 4B and 4C show the form of applying voltages generated from the lamp driver 750 when light emitting diodes (“LEDs”) are connected in parallel and in series, respectively. FIG. 5A is a register generally included in an integrated circuit (IC) and FIG. 5B is a table showing an example of setting voltages using the register of FIG. 5A. FIGS. 6A and 6B show examples of a constant current source, and FIG. 7 is a schematic diagram of an exemplary embodiment of the LCD of FIG. 3 in which lamps are mounted on a main FPC.

Herein, for convenience of explanation, the generally used LED is taken as an example of the lamp and two LEDs are provided.

With reference to FIGS. 4A to 4C, the lamp driver 750 applies a plurality of voltages Va, Vb and Vc to lamps LD1 and LD2.

As known, brightness of the LEDs LD1 and LD2 changes according to current, and because the LEDs LD1 and LD2 are diodes, the basic voltages Va, Vb and Vc are applied for conduction.

The two diodes LD1 and LD2 are connected in parallel in FIG. 4B and the two diodes LD1 and LD2 are connected in series in FIG. 4C.

The voltages Va, Vb and Vc can be generated as required from several constituent elements installed in the integration chip 700.

For example, the voltages Va, Vb and Vc can be obtained from the DC/DC converter 710, and in this case, as stated above, the DC/DC converter 710 sequentially generates the voltages Va, Vb and Vc using the input voltage Vin and may use the voltage Vx generated in this process as it is. If the generated voltage Vx fails to satisfy driving conditions of the lamps LD1 and LD2, more finely divided voltages generated from the gray voltage generator 800 or voltages generated from a power regulator (not shown) can be used.

FIG. 5A shows a register generally included in an integrated circuit (“IC”) such as the integration chip 700, and FIG. 5B shows values of voltages (Va) set by using the register of FIG. 5A.

As shown in FIG. 5A, when five bits of first to fifth bits L1˜L5, among the most significant bits, are allocated, a total of 32 values of voltages can be set, and as shown in FIG. 5B, for example, 1.5V to 4.6V can be set. The other voltages Vb and Vc can be also set in the same manner by using the register.

As shown in FIG. 6A, the lamp driver 750 includes a constant current source CS.

For example, when the voltages Va and Vb applied to an anode and a cathode of the two lamps LD1 and LD2 connected in series are determined, the constant current source CS can make a certain current ‘I’ flow at the lamps LD1 and LD2 to sustain brightness uniformly.

As known, the constant current source CS can be implemented by using an NPN transistor and the diode or an operation amplifier and a resistor, etc. FIG. 6B shows an example of the constant current source CS of FIG. 6A including an operational amplifier OP connected with a certain voltage V1, an NPN transistor TR, and a plurality of resistors R1 and R2.

Accordingly, inclusion of the lamp driver 750 for driving the lamps LD1 and LD2 in the integration chip 700 can reduce a fabrication unit cost because a cost for separately fabricating the lamp driver 750 as in the related art can be saved. In addition, because a space for mounting the lamp driver 750 is not required, the space of the main FPC 680M or the driving FPC 650 can also be saved to reduce the fabrication unit cost.

Also, as shown in FIG. 7, because the lamps LD1 and LD2 are directly mounted on the main FPC 680M or the driving FPC 650 (FIG. 3B), a distance between the lamp driver 750 and the lamps LD1 and LD2 can be reduced to thus minimize a loss of a signal according to wire resistance or contact resistance.

As described above, by installing the lamp driver 750 in the integration chip 700, the fabrication unit cost can be lowered.

While the present invention has been described in connection with what is presently considered to be practical exemplary embodiments, it is to be understood that the present invention is not limited to the disclosed exemplary embodiments, but, on the contrary, is intended to cover various modifications and equivalent arrangements included within the spirit and scope of the appended claims.

What is claimed is:

1. A liquid crystal display (LCD) comprising:
a first display panel;
a second display panel;
a light source unit for providing light to the first and second display panels and comprising a plurality of lamps; and
a driving circuit chip for driving both the first and second display panels,
wherein the driving circuit chip comprises a lamp driver for providing a plurality of voltages and a uniform current to the light source unit.

2. The LCD of claim 1, wherein the driving circuit chip comprises a voltage generator for generating a plurality of driving voltages and the lamp driver applies at least two of the plurality of driving voltages to the light source unit.

3. The LCD of claim 2, wherein the lamp driver comprises a constant current source for providing the uniform current.

4. The LCD of claim 3, further comprising:
a first flexible printed circuit (FPC) film attached on the first display panel and;
a connection part connected between the first FPC film and the light source unit.

5. The LCD of claim 4, wherein the lamps are light emitting diodes (LEDs).

6. The LCD of claim 3, further comprising:
a first flexible printed circuit (FPC) attached on the first display panel; and
a second FPC having a cutout portion exposing the second display panel,
and the lamps are mounted on the first FPC or the second FPC.

7. The LCD of claim 2, wherein the driving circuit chip comprises a DC/DC converter for generating the plurality of driving voltages based on an input voltage, and the voltage generator is the DC/DC converter.

8. The LCD of claim 2, wherein the driving circuit chip comprises a gray voltage generator for generating a plurality of gray voltages, and the voltage generator is the gray voltage generator.

9. The LCD of claim 1, wherein the first and second display panels each comprise a plurality of pixels, each pixel comprising a switching element, and first and second signal lines connected with the switching elements, respectively.

10. The LCD of claim 9, further comprising:
a gate driver for generating a gate signal and applying the gate signal to the first signal lines; and
a data driver for generating a data voltage and applying the data voltage to the second signal lines.

11. The LCD of claim 10, wherein the driving circuit chip further comprises the gate driver and the data driver.

12. The LCD of claim 11, wherein the driving circuit chip is mounted on the first display panel.

13. The LCD of claim 5, wherein the driving circuit chip further comprises a register for setting values of at least one of the polarity of the driving voltages.

14. The LCD of claim 13, wherein the light emitting diode includes a plurality of diodes connected in series, and the plurality of the driving voltages include a first voltage and a second voltage applied to both ends of the diodes, respectively, and the register set the first voltage in a predetermined range of values.

15. The LCD of claim 13, wherein the light emitting diode includes a plurality of diodes connected in series, and the plurality of the driving voltages include a first voltage and a second voltage applied to both ends of the diodes, respectively, and the register set the second voltage in a predetermined range of values.

16. The LCD of claim 13, wherein the light emitting diode includes a plurality of diodes connected in parallel, and the plurality of the driving voltages include a first voltage applied to one end of the plurality of the diodes and a plurality of second voltages applied to other ends thereof, and the register set the first voltage in a predetermined range of values.

17. The LCD of claim 13, wherein the light emitting diode includes a plurality of diodes connected in parallel, and the plurality of the driving voltages include a first voltage applied to one end of the plurality of the diodes and a plurality of second voltages applied to other ends thereof, and the register set the second voltages in a predetermined range of values.
